(19) United States
(12) Patent Application Publication
(10) Pub. No.: US 2025/0341534 A1
(43) Pub. Date: Nov. 6, 2025

(54) INSPECTION DEVICE, INSPECTION METHOD AND STORAGE MEDIUM

(71) Applicant: CANON KABUSHIKI KAISHA, Tokyo (JP)

(72) Inventor: HIROSHI KII, Kanagawa (JP)

(21) Appl. No.: 19/266,729

(22) Filed: Jul. 11, 2025

Related U.S. Application Data
(63) Continuation of application No. PCT/JP2023/045326, filed on Dec. 18, 2023.

(30) Foreign Application Priority Data
Jan. 12, 2023 (JP) 2023-003287

(51) Int. Cl. G01N 35/04

(52) U.S. Cl. CPC G01N 35/04; G01N 2035/0422

(57) ABSTRACT

An inspection device including a measurement part, a liquid supply area where a liquid supply step is performed, a relay area where a plate for which a reaction step has been completed is located, and a mounting part on which a plurality of plates is mounted at different positions, includes a first conveyance part configured to move the mounting part to locate a plate selected from among the plurality of plates mounted on the mounting part in the liquid supply area and the relay area at different times, a second conveyance part configured to convey the selected plate located on the relay area to the measurement part, wherein the liquid supply step, which is performed on the selected plate, includes at least a period in which the liquid supply step is performed in parallel with the reaction step, which is performed on at least one of the plates other than the selected plate from among the plurality of plates.

### CROSS-REFERENCE TO RELATED APPLICATIONS

This application is a Continuation of International Patent Application No. PCT/JP2023/045326, filed Dec. 18, 2023, which claims the benefit of Japanese Patent Application No. 2023-003287, filed Jan. 12, 2023, both of which are hereby incorporated by reference herein in their entirety.

### BACKGROUND

### Field of the Technology

The present disclosure relates to an inspection device and an inspection method.

### Description of the Related Art

An array plate having a configuration in which a number of substances, such as proteins, peptides, or nucleic acids, are fixed in the form of spots on a substrate is known. The use of such an array plate enables observation of interactions between a number of fixed substances and substances in a sample at once. This makes it possible to comprehensively analyze interactions with a number of substances including a sample derived from a living organism, such as blood, cell extract, saliva, or intercellular fluid.

A method for obtaining optical information about spots, where an interaction of interest has occurred, by selective fluorescent labeling of the spots is known as a sample measurement method using an array plate. As a device for observing a fluorescent-labeled sample, a confocal laser microscope is known. The confocal laser microscope includes an irradiation optical system, a fluorescence detection optical system, and a two-dimensional scanning system. The fluorescence detection optical system includes a function for detecting the amount of fluorescence light from spots labeled by a fluorescence probe.

The two-dimensional scanning system includes a function for obtaining a fluorescence image of a spot area on an array plate by two-dimensionally scanning the array plate or an optical system.

Japanese Unexamined Patent Application Publication No. 2011-501965 discusses an inspection technique for performing a reaction step including labeling on a cell of a closed system for holding a plate and a liquid reagent, which is called a flow cell, and a measurement step of optically obtaining a labeled pattern. In the reaction step, a processing time for each plate may be longer than that in the measurement step, and the overall inspection time may be rate-determined. Accordingly, Japanese Unexamined Patent Application Publication No. 2011-501965 discusses a technique for performing the reaction step on a plurality of plates in parallel, whereby the throughput in inspection is improved.

In the technique for performing the reaction step on a plurality of flow cells in parallel as discussed in Japanese Unexamined Patent Application Publication No. 2011-501965, processes for supplying and discharging a plurality of liquid reagents require a detachment/attachment step for liquid supply/discharge systems and flow cells, which limits the throughput in loading. Further, in the technique discussed in Japanese Unexamined Patent Application Publication No. 2011-501965, it is necessary to provide a number of liquid supply devices and discharge devices corresponding to the number of flow cells to be processed in parallel, or it is necessary to provide a liquid supply/discharge mechanism including a number of flow channel switching functions corresponding to the number of flow channels and the types of liquid reagents. In this case, the inspection device is increased in size and complicated.

### SUMMARY

The present disclosure has been made to solve the above-described issues and is directed to effectively performing a series of steps, including a liquid supply step, a reaction step, and a measurement step, as successive processes on a plurality of plates with a simple device configuration.

According to an aspect of the present disclosure, an inspection device that performs a liquid supply step of supplying a predetermined chemical liquid to a reservoir of a plate and performs a reaction step and a measurement step on the plate in which the chemical liquid is stored, the inspection device including a measurement part configured to perform the measurement step, a liquid supply area corresponding to a position where the liquid supply step of supplying a predetermined liquid to the reservoir is performed in the liquid supply step, a relay area corresponding to a position where the plate for which the reaction step has been completed is located, a first conveyance part including a mounting part on which a plurality of plates is mounted at different positions, respectively, the first conveyance part being configured to move the mounting part to locate a plate selected from among the plurality of plates mounted on the mounting part in the liquid supply area and the relay area at different times, the plate being, and a second conveyance part configured to convey the selected plate located on the relay area to the measurement part, wherein the liquid supply step, which is performed on the selected plate, includes at least a period in which the liquid supply step is performed in parallel with the reaction step, which is performed on at least one of the plates other than the selected plate from among the plurality of plates

According to another aspect of the present disclosure, an inspection method for inspecting a plurality of plates, includes a liquid supply step of causing the plurality of plates located at different positions, respectively, to integrally move, conveying a plate selected from among the plurality of plates to a liquid supply area, and supplying a predetermined chemical liquid to a reservoir of the selected plate, a reaction step of reacting the chemical liquid in the selected plate for which the liquid supply step has been completed, and a measurement step of causing the plurality of plates to integrally move, conveying the selected plate for which the reaction step has been completed to a relay area, conveying the selected plate from the relay area to a measurement part, and performing a measurement on the selected plate, wherein the liquid supply step, which is performed on the selected plate, includes at least a period in which the liquid supply step is performed in parallel with the reaction step, which is performed on at least one of the plates other than the selected plate from among the plurality of plates.

Further features of the present invention will become apparent from the following description of exemplary embodiments with reference to the attached drawings.

### BRIEF DESCRIPTION OF THE DRAWINGS

FIG. 1 is a plan view schematically illustrating an example of an inspection device according to an embodiment of the present disclosure.

FIG. 2 is a sectional view taken along a line A-A′ of the inspection device illustrated in FIG. 1.

FIG. 3 is a plan view illustrating an array plate with a frame to be used for the inspection device.

FIG. 4 is a plan view schematically illustrating another example of the inspection device according to the embodiment.

FIG. 5 is a plan view schematically illustrating another example of the inspection device according to the embodiment.

FIG. 6 is a plan view schematically illustrating an operation state of the inspection device corresponding to a predetermined step.

FIG. 7 is a plan view schematically illustrating an operation state of the inspection device corresponding to a predetermined step.

FIG. 8 is a plan view schematically illustrating an operation state of the inspection device corresponding to a predetermined step.

FIG. 9 is a plan view schematically illustrating an operation state of the inspection device corresponding to a predetermined step.

FIG. 10 is a chart illustrating steps of an inspection method according to the embodiment in chronological order.

FIG. 11A is a schematic diagram illustrating a modified example of the inspection method according to the embodiment.

FIG. 11B is a schematic diagram illustrating a modified example of the inspection method according to the embodiment.

FIG. 11C is a schematic diagram illustrating a modified example of the inspection method according to the embodiment.

FIG. 11D is a schematic diagram illustrating a modified example of the inspection method according to the embodiment.

FIG. 11E is a schematic diagram illustrating a modified example of the inspection method according to the embodiment.

### DESCRIPTION OF THE EMBODIMENTS

The following describes desirable embodiments to which the present disclosure can be applied, in detail, with reference to the drawings. In the following description and drawings, common reference numerals are assigned to common components across a plurality of drawings. Therefore, common components are described by referring to the plurality of drawings, and the description of components with common reference numerals is omitted as appropriate.

### [Inspection Device]

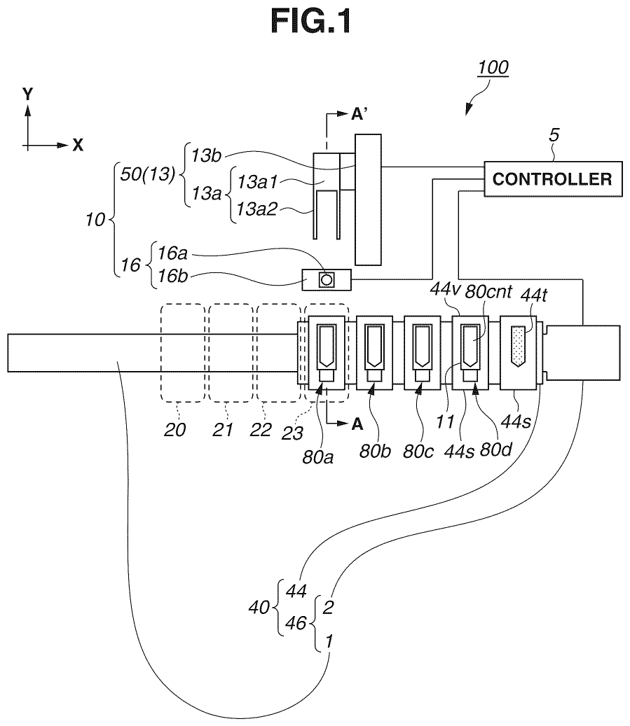

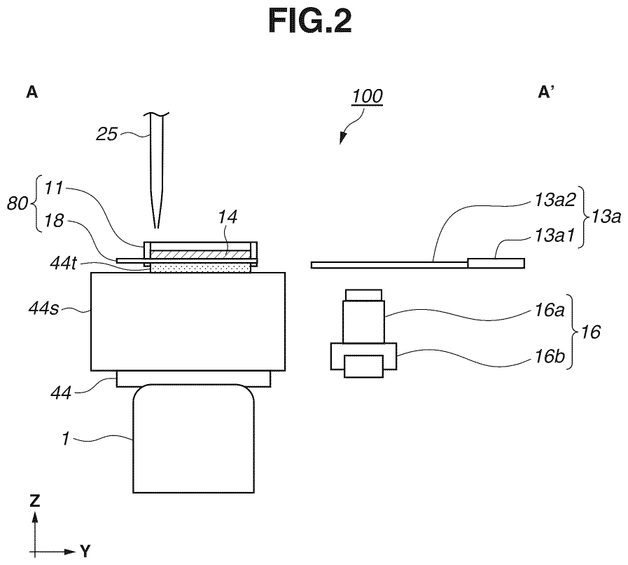

FIG. 1 is a plan view schematically illustrating an inspection device according to an embodiment of the present disclosure. FIG. 2 is a sectional view taken along a line A-A′ of the inspection device illustrated in FIG. 1. Illustration of a controller is omitted in FIG. 2.

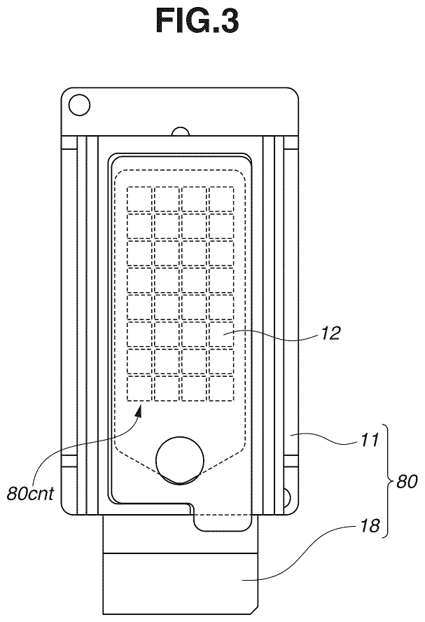

FIG. 3 is a plan view illustrating an array plate with a frame to be used for the inspection device.

An inspection device 100 according to the present embodiment corresponds to a device for optically inspecting a liquid including a sample stored in a frame of a plurality of plates 80 (80a, 80b, . . . 80e) with frames. In other words, the inspection device 100 is a device for performing a mounting step, a liquid discharge step, a liquid supply step, a reaction step, and a measurement step on each of the plates 80. The inspection device 100 includes a measurement part 10 for performing the measurement step, a liquid supply area 22 corresponding to a position where the liquid supply step of supplying a predetermined liquid to a reservoir is performed in the liquid supply step, and a relay area 23 corresponding to a position where the plate for which the reaction step has been completed is located. The inspection device 100 further includes a mounting part 44 on which the plurality of plates 80 is mounted at different positions, respectively, and a first conveyance part 40 for moving a plate 80i selected from among the plurality of plates 80 (80a, 80b, . . . 80e) mounted on the mounting part 44. The first conveyance part 40 is configured to move the mounting part 44 to be located on the liquid supply area 22 and the relay area 23 at different times, respectively. The inspection device 100 further includes a second conveyance part 50 for conveying the selected plate 80i, which is located on the relay area 23, to the measurement part 10. In the inspection device 100, a liquid supply step S22 to be performed on the selected plate 80i is executed so as to include at least a period in which the liquid supply step is performed in parallel with a reaction step S20 to be performed on at least one of the plates other than the selected plate from among the plurality of plates 80. The first conveyance part 40 is operated so that the liquid supply step S22 to be performed on the selected plate 80i includes at least a period in which the liquid supply step is performed in parallel with the reaction step S20 to be performed on at least one of the plates other than the selected plate from among the plurality of plates 80.

Each of the plates 80 includes a plate 18 and a reservoir 80cnt configured to store a predetermined liquid. The plates 18 have a configuration in which substances derived from a living organism, such as proteins or peptides, are fixed as spots on one surface of the plate. The reservoir 80cnt includes an open system reservoir including a frame member 11 and the plate 18. Specifically, in the reservoir 80cnt, a plurality of spots 12 is provided in a matrix on an area surrounded by the frame member 11 on one surface of the plate 18. A predetermined biological material is fixed onto each of the spots 12. Examples of the biological material include antibody, antigen, phosphorylated protein, dephosphorylated protein, deoxyribonucleic acid (DNA), ribonucleic acid (RNA), and disease marker. Before use, a chemical liquid 14 for stably protecting the biological material fixed onto each of the spots 12 may be supplied to the plates 80.

The first conveyance part 40 includes the mounting part 44 on which the plates 80 are mounted, and a linear stage 46 on which the mounting part 44 is placed to be movable in an X-direction.

### (Mounting Part)

The mounting part 44 is a plate-like member having a rectangular shape in plan view in which the longitudinal direction corresponds to a first direction (X-direction in the illustrated example). The mounting part 44 includes a plurality of plate stages 44s. The plurality of plate stages 44s is arranged at different positions in the X-direction and is aligned. Each of the plates 80 to be inspected is detachably mounted on a corresponding one of the plate stages 44s. FIG. 1 illustrates a case where the mounting part 44 is provided with five plate stages 44s and the plates 80 are placed on four of the plate stages 44s, respectively. Each of the plate stages 44s is provided with a temperature control mechanism 44t and a shaking mechanism 44v. The temperature control mechanism 44t controls the temperature of the plate 80 that is mounted in contact with the corresponding plate stage 44s in a heat-transfer manner. In other words, the temperature control mechanism 44t controls the temperature of the plate 80 via the corresponding plate stage 44s. Being in contact in a heat-transfer manner can also be expressed as being in contact in a heat transferrable manner. The temperature control mechanisms 44t provided for the respective plate stages 44s control the temperature of the plates 80 independently. Each of the shaking mechanisms 44v is mechanically coupled to the plate 80 placed on the corresponding plate stage 44s, and shakes the plate 80. The shaking mechanisms 44v provided for the respective plate stages 44s shake the plates 80 independently. Each of the plates 80 is heated by the corresponding temperature control mechanism 44t and is shaken by the corresponding shaking mechanism 44v, whereby the reaction of the liquid in the plates 80 are uniformized and promoted.

The linear stage 46 includes a stage part 1 and a base part 2 connected to the stage part 1. The stage part 1 extends along the different positions at which the plurality of plates 80 is mounted, on the mounting part 44. The base part 2 includes a predetermined driving mechanism for moving the mounting part 44 located on the stage part 1 in the X-direction along the stage part 1. Examples of the driving mechanism may include actuators, such as a servomotor that operates using electric energy, an electromagnetic motor, a vibrating actuator, and a hydraulic actuator. The driving mechanism included in the linear stage 46 is required to perform a sophisticated operation to move the mounting part 44 to a target position at a designated speed, and thus, a servomotor, an electromagnetic motor, or the like is suitably used as the driving mechanism. The first conveyance part 40 is configured to move the mounting part 44 on which the plurality of plates 80 is mounted at different positions, in the X-direction, whereby the plurality of plates 80 moves integrally. Driving of the first conveyance part 40 causes the mounting part 44 to move in such a manner that the plate 80 selected from among the plurality of plates 80 is located on a mounting area 20, a discharge area 21, the liquid supply area 22, or the relay area 23 at different times. In other words, the first conveyance part 40 conveys the mounting part 44 in such a manner that the plate 80 selected from among the plurality of plates 80 is located on the mounting area 20, the discharge area 21, the liquid supply area 22, or the relay area 23 at different times. In the first conveyance portion 40, the driving mechanism of the base part 2 may be provided separately from the stage part 1.

In the inspection device 100, the mounting area 20, the discharge area 21, the liquid supply area 22, and the relay area 23 are provided in this order from the left in the X-direction in FIG. 1 and are provided at predetermined positions, respectively. The mounting area 20, the discharge area 21, the liquid supply area 22, and the relay area 23 are arranged along a path for the first conveyance part 40 to move the mounting part 44. The present embodiment is not limited to the case where the mounting area 20, the discharge area 21, the liquid supply area 22, and the relay area 23 are defined at intervals as illustrated in FIG. 1. At least two areas of the mounting area 20, the discharge area 21, the liquid supply area 22, and the relay area 23 may include an overlapping part. The configuration in which the areas are partially or entirely overlap each other enables space saving in the inspection device and reduction in the footprint. The mounting area 20, the discharge area 21, the liquid supply area 22, and the relay area 23 may be modified in various forms other than the configuration illustrated in FIG. 1, for example, the areas may include an overlapping part, or the areas may be arranged differently on a conveyance path, as long as the areas are located on the conveyance path of the first conveyance part 40.

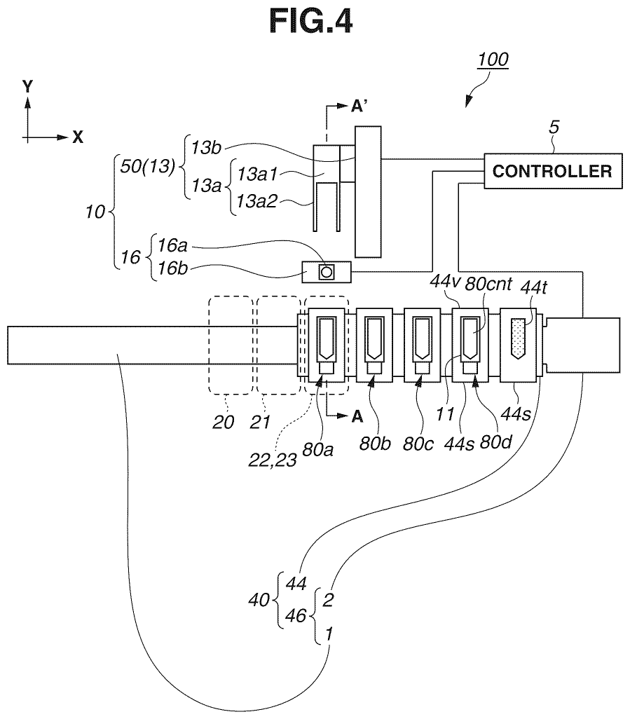

The above-described overlapping part may be a common area that is included in each of the liquid supply area 22 and the relay area 23. As an example of such a case, FIG. 4 illustrates a case where the liquid supply area 22 and the relay area 23 entirely overlap each other (relay area 23 also functions as the liquid supply area 22). In this case, as long as the liquid supply mechanism does not interfere with the conveyance of the plate 80 from the relay area 23 to the measurement part 10, space saving and reduction in the footprint are realized without causing any problem with the configuration. If the liquid supply mechanism is spaced apart from the liquid supply area 22 during a period other than a liquid supply period, the liquid supply mechanism does not interfere with the conveyance of the plate 80.

The mounting area 20 is an area for sequentially mounting the plates 80 onto the mounting part 44. A plate mounting mechanism (not illustrated) is provided on the mounting area 20. Driving of the first conveyance part 40 causes the mounting part 44 to move in the X-direction, and the plate mounting mechanism causes the plate 80 to be mounted and fixed onto the plate stage 44s conveyed to the mounting area 20 of the mounting part 44. The series of conveyance operation is performed on a predetermined number of plates 80, whereby the plurality of plates 80 is mounted on the mounting part 44.

The discharge area 21 is an area corresponding to a position where the liquid discharge step of discharging the liquid stored in the reservoir 80cnt of the plate 80 is performed, and the plate 80 to be subjected to the liquid discharge step is conveyed to the discharge area 21. The discharge area 21 is provided with a plate tilt mechanism (not illustrated). Driving of the first conveyance part 40 causes the mounting part 44 to move in the X-direction, so that the plate stage 44s on which the plate 80 reserving the liquid obtained after completion of the reaction is placed is conveyed to the discharge area 21. In the discharge area 21, driving of the plate tilt mechanism causes an upper part of the plate stage 44s to be tilted in a Z-direction with a lower part of the plate stage 44s on the discharge area 21 as a fulcrum, and the liquid stored in the plate 80 is discharged. As a mechanism for discharging the stored liquid, a configuration for sucking the liquid using a pipetter may be used, like in the liquid supply mechanism to be described below.

The liquid supply area 22 is an area corresponding to a position where the liquid supply step of supplying the predetermined liquid to the reservoir 80cnt of the plate 80, and the plate 80 to be subjected to the liquid supply step is conveyed to the liquid supply area 22. The liquid supply area 22 is provided with the liquid supply mechanism (not illustrated), and the liquid supply mechanism includes a pipetter 25 including a disposable chip. Driving of the first conveyance part 40 causes the mounting part 44 to move in the X-direction, and the plate stage 44s on which the plate 80 for which the liquid discharge has been completed is placed is conveyed to the liquid supply area 22. In the liquid supply area 22, driving of the liquid supply mechanism causes the predetermined liquid to be supplied to the reservoir 80cnt of the plate 80 from the pipetter 25 including the disposable chip. The plate 80 to which the liquid has been supplied is moved to a predetermined position on the first conveyance part 40 along with the subsequent liquid discharge and liquid supply processes for the plate 80, and then the reaction step for the supplied liquid is carried out. During the reaction step, the temperature control mechanism 44t and the shaking mechanism 44v are driven, as necessary, on the plate stage 44s on which the plate 80 is placed to promote the reaction of the liquid, so that a temperature control operation and a shaking operation are performed on the plate 80.

The relay area 23 is an area corresponding to a position where the plate 80 for which the reaction step has been completed is located, and serves as a relay position for movement of the plate 80 between the mounting part 44 and the measurement part 10.

The measurement part 10 includes a substrate scanning part 13 for moving the selected plate 80 in a predetermined direction, and is configured to perform a predetermined measurement by scanning the area of the spots 12 on the reservoir 80cnt of the plate 80. In the present embodiment, the measurement part 10 includes the second conveyance part 50 for conveying the selected plate 80 located on the relay area 23 to the measurement part 10, and an optical system scanning part 16 for optically measuring the spots 12 on the plate 80. The second conveyance part 50 also serves as the substrate scanning part 13 and includes a holding part 13a for holding the plate 80, and a first scanning part 13b for moving the holding part 13a. The optical system scanning part 16 includes an optical measurement system 16a for optically measuring the plate 80 and a measurement scanning part 16b for moving the optical measurement system 16a.

The holding part 13a includes a conveyance part 13al coupled to the first scanning part 13b, and a pair of support parts 13a2 that have a divided shape and are provided on the conveyance part 13a1. The holding part 13a holds the plate 80 by inserting the support parts 13a2 into a space below the lower surface of the selected plate 80 that is located on the relay area 23 and is subjected to the measurement step.

The first scanning part 13b conveys the selected plate 80 located on the relay area 23 to the measurement part 10. Driving of the first scanning part 13b causes the plate 80 held by the holding part 13a to move in a second direction intersecting the first direction, which is a Y-direction perpendicular to the X-direction in this case. Driving of the first scanning part 13b causes the plate 80 to reciprocate in the Y-direction between the relay area 23 and the measurement part 10. The support parts 13a2 of the holding part 13a are two support members having a width narrower than a width of the plate 80, and a width of a space between the pair of support parts 13a2 is greater than a width of the area of the plurality of spots 12 on the plate 80. Thus, the support parts 13a2 do not overlap the spots 12 on the plate 80 as viewed from below, and consequently, the optical measurement system 16a is able to measure the entire area of the plurality of spots 12 in a state where the support parts 13a2 do not interfere with the measurement.

The optical measurement system 16a obtains optical information about the spots 12 by performing a predetermined measurement on the spots 12 on the reservoir 80cnt of the plate 80 located on the measurement part 10. As the optical information, fluorescence image information is able to be obtained. In a case where a fluorescent substance is used as a labeling substance, the florescent substance is not particularly limited as long as the optical measurement system 16a can excite the fluorescent substance and can detect the fluorescence from the spots 12. Examples of an excitation light source for exciting the fluorescent substance include a laser light source, a light-emitting diode, a mercury arc, and a tungsten halogen lamp. To detect the fluorescence, a charge-coupled device (CCD) camera, an optical diode, or the like may be used.

The measurement scanning part 16b includes a driving mechanism for moving the optical measurement system 16a in a predetermined direction, or the X-direction in the example illustrated in FIG. 1. Examples of the driving mechanism may include actuators, such as a servomotor that operates using electric energy, an electromagnetic motor, a vibrating actuator, and a hydraulic actuator. The driving mechanism included in the measurement scanning part 16b is required to perform a sophisticated operation to move the optical measurement system 16a to a target position at a designated speed, and thus, a servomotor, an electromagnetic motor, or the like is suitably used as the driving mechanism. The measurement scanning part 16b uses the range in the X-direction of the area of the spots 12 on the reservoir 80cnt of the plate 80 as a scanning range for the optical measurement system 16a.

The measurement step that is performed by the measurement part 10 is performed by two-dimensionally scanning the area of the spots 12 on the reservoir 80cnt of the plate 80. In the inspection device 100 according to the present embodiment, the second conveyance part 50 also serves as the substrate scanning part 13 of the measurement part 10. In the measurement step, the measurement scanning part 16b causes the optical measurement system 16a to move in the X-direction relatively to the plate 80, whereby scanning in the X-direction is performed. The second conveyance part 50 causes the plate 80 to move in the Y-direction relatively to the optical measurement system 16a via the holding part 13a, whereby scanning in the Y-direction is performed. As described above, two-dimensional scanning relative to the plate 80 is able to be performed. The measurement part 10 obtains a two-dimensional fluorescence image of the plate 80 by two-dimensional scanning as described above.

Here, in the measurement step, a moving speed for scanning of the plate 80 in the Y-direction via the holding part 13a by driving of the second conveyance part 50 may be rate-determined to a moving speed for scanning of the optical measurement system 16a in the X-direction by driving of the measurement scanning part 16b. In this case, the second conveyance part 50 defines the moving speed of the plate 80 from the relay area 23 to the measurement part 10 to be higher than the moving speed of the plate 80 in scanning by the substrate scanning part 13 in the scanning step.

A controller 5 is a control unit for controlling driving operations of the driving mechanism for the first conveyance part 40, the driving mechanism for the second conveyance part 50, the optical measurement system 16a, the measurement scanning part 16b, the temperature control mechanism 44t, the shaking mechanism 44v, the plate tilt mechanism, the liquid supply mechanism, and the like in an integrated manner. The controller 5 includes a central processing unit (CPU), and the CPU implements each driving operation by executing operation programs.

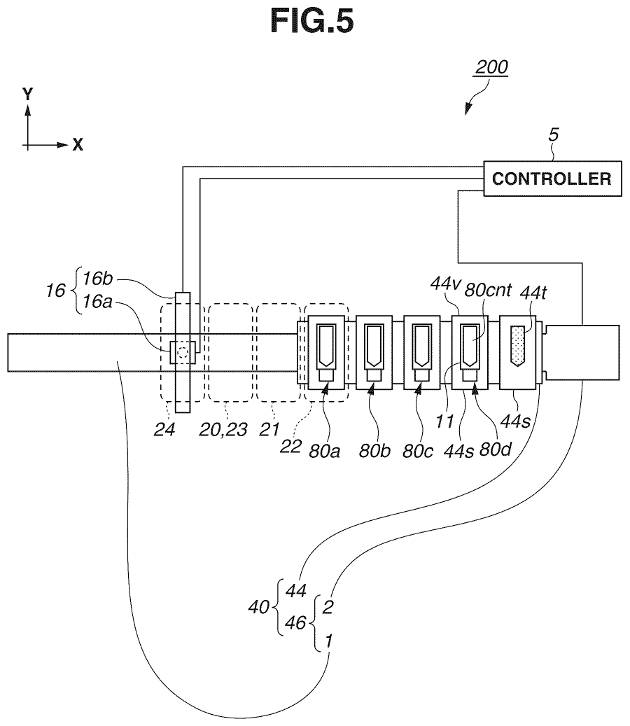

While the present embodiment discloses a configuration example of the inspection device 100 in which the second conveyance part 50 conveys the plate 80 in the second direction (Y-direction) intersecting the first direction (X-direction) via the holding part 13a in the measurement part 10, the present embodiment is not limited to this example. The inspection device may be configured to move an array plate selected by the second conveyance part 50 in the first direction (X-direction) in the measurement part. FIG. 5 illustrates an example of the inspection device having such a configuration. In an inspection device 200, the mounting area 20 also serves as the relay area 23. Instead of providing the second conveyance part 50 and the optical system scanning part 16 at the locations illustrated in FIG. 1, a measurement area 24 may be provided at a location adjacent to the mounting area 20, and the optical system scanning part 16 including the optical measurement system 16a and the measurement scanning part 16b is located on the front (at a position facing front surface of the plate 80) of the measurement area 24 in the Z-direction. The first conveyance part 40 also serves as the second conveyance part 50 for conveying the selected plate 80 to the measurement area 24 from the relay area 23, and conveys the selected plate 80 to the measurement area 24 and performs the measurement step on the plate 80. In the measurement step, the first conveyance part 40 causes the plate 80 to move relatively to the optical measurement system 16a and performs scanning in the X-direction, and the measurement scanning part 16b causes the optical measurement system 16a to move relatively to the plate 80 and performs scanning in the Y-direction. With this relative two-dimensional scanning, a two-dimensional fluorescence image of each of the spots 12 on the reservoir 80cnt of the plate 80 is able to be obtained. Also, in the inspection device 200, the operation and effect similar to those of the inspection device 100 illustrated in FIG. 1 according to the present embodiment is able to be obtained.

In the inspection device 100 according to the present embodiment, at least the liquid supply step and the reaction step in the series of driving operation by the controller 5 on the plurality of plates 80 are carried out in association with each other as described below. In other words, the liquid supply step to be performed on the selected plate 80 includes at least a period in which the liquid supply step is performed in parallel (simultaneously) with the reaction step to be performed on at least one of the plates 80 other than the selected plate 80 from among the plurality of plates 80.

In the present embodiment, the inspection device having the above-described configuration performs a part of another reaction step simultaneously with the liquid supply step using the period in which at least the liquid supply step is performed on the predetermined plate 80. Consequently, steps are able to be effectively executed and a series of steps, including the liquid supply step, the reaction step, and the measurement step, on the plurality of plates 80 is able to be effectively performed as successive processes with a simple device configuration.

### [Inspection Method]

An inspection method using the inspection device having the above-described configuration will be described below.

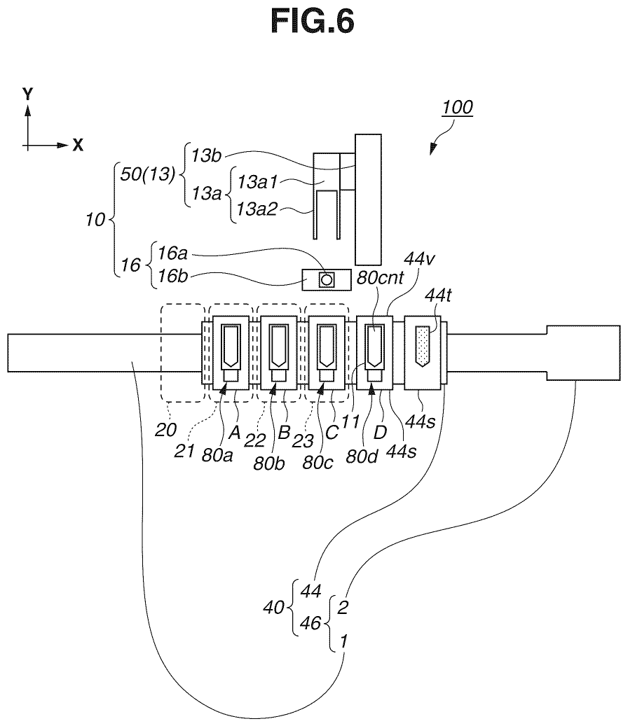

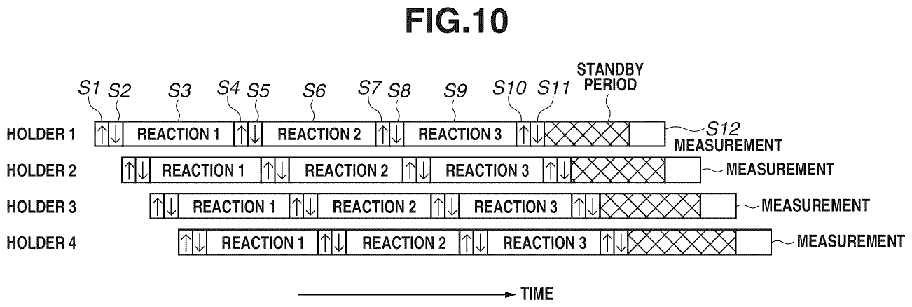

FIGS. 6 to 9 are plan views each schematically illustrating an operation state of the inspection device corresponding to a predetermined step. In FIGS. 6 to 9, illustration of the controller 5 is omitted. FIG. 10 is a chart illustrating steps of the inspection method according to the present embodiment in chronological order.

In the inspection method to be described below, like in the example illustrated in FIG. 1, the plurality of plates 80a to 80d are mounted on the four plate stages 44s, which are the plate stages 44s except for the plate stage 44s located at the right end, among the five plate stages 44s that are aligned in a row on the mounting part 44. For convenience of explanation, these plates 80 are hereinafter referred to as plates A, B, C, and D in this order from left to right. The plates A, B, C, and D are sequentially placed on the plate stages 44s in the mounting area 20 in the mounting step.

In the present embodiment, various types of biological materials are fixed onto the spots 12 on the reservoir 80cnt of each of the plates A to D. Examples of the biological materials include antibody, antigen, phosphorylated protein, dephosphorylated protein, DNA, RNA, and disease marker. A chemical liquid for protecting the reservoir 80cnt is supplied to each of the plates A to D. The plates A to D may be processed with a nonspecific adsorption preventing agent including a blocking agent to prevent substances included in a sample from being directly bound to the plate.

While the present embodiment illustrates a case where the four plates 80 are placed on the mounting part 44, the present embodiment is not limited to this case. Five or more plates 80 may be placed, as necessary, on the mounting part 44 on which three or less, or five or more plate stages 44s are provided. While the present embodiment illustrates a case where reactions 1, 2, and 3 are performed as the reaction step, the present embodiment is not limited to these examples. For example, two reaction steps (reaction 1, reaction 2) may be performed, or four or more reaction steps (reaction 4, . . . ) may be performed. While the present embodiment illustrates a case where liquid discharge and liquid supply steps and reactions 1 to 3 are performed on each of the plates A to D in the same manner, the present embodiment is not limited to these examples. Different liquid discharge and liquid supply steps or different reaction steps may be performed on each plate.

First, the liquid discharge step is performed on the plate A (step S1).

Specifically, as illustrated in FIG. 6, the first conveyance part 40 causes the mounting part 44 to move in the X-direction and conveys the plate A to the discharge area 21. The plate tilt mechanism causes the upper part of the plate stage 44s located on the discharge area 21 to be tilted in the Z-direction, whereby the chemical liquid stored in the plate A placed on the plate stage 44s is discharged.

Next, the liquid supply step is performed on the plate A (step S2).

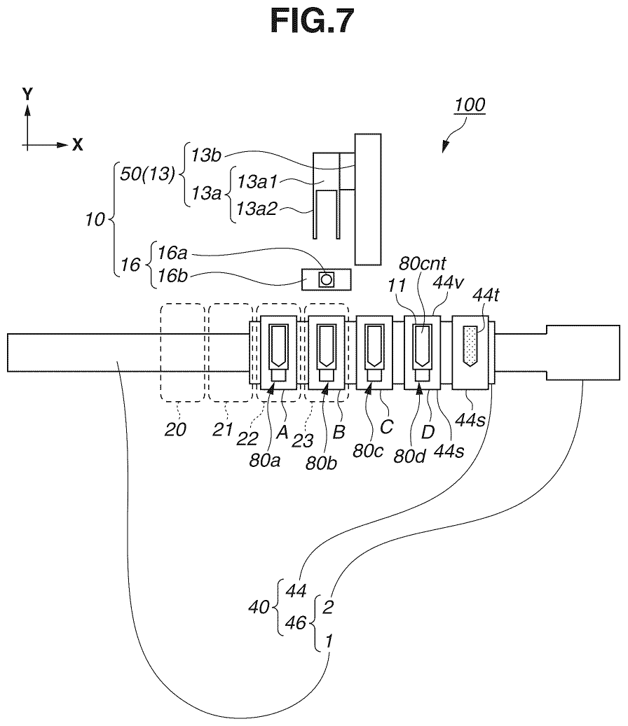

Specifically, after a plate cleaning step is performed several times, as illustrated in FIG. 7, the first conveyance part 40 causes the mounting part 44 to move in the X-direction and conveys the plate A, for which the liquid discharge step has been completed, to the liquid supply area 22. The liquid supply mechanism supplies a predetermined liquid to the reservoir 80cnt of the plate A placed on the plate stage 44s located on the liquid supply area 22.

The cleaning step is performed by placing a cleaning liquid on the spots 12 to reduce the chemical liquid after cleaning. The cleaning step may be repeatedly performed several times. As the cleaning liquid, water, normal saline, or buffer solution, such as phosphate buffer solution, is used. An additive, such as a surfactant or a preservative, may be added to the cleaning liquid, as necessary. Examples of the predetermined liquid that is supplied in step S2 may include a sample. Examples of the sample include a substance derived from a living organism, an extract from a living organism, blood, a substance derived from blood, food, a substance derived from food, a natural product, a substance derived from a natural product, and a substance derived from a culture solution. The sample includes a target as a substance that can be expected to react with biological materials fixed onto the spots 12. Examples of the target include antibody, antigen, phosphorylated protein, dephosphorylated protein, DNA, RNA, and disease marker. A predetermined reagent may be added to the sample in advance. A labeling substance (fluorescent substance) may be preliminarily bound to the target in the sample.

Next, the reaction 1 is performed as a first reaction step on the plate A (step S3). In this processing, steps S1, S2, and S3 are sequentially performed on the plates B to D in parallel with step S3 on the plate A.

Specifically, the first conveyance part 40 causes the mounting part 44 to move in the X-direction, conveys the plate B to the discharge area 21, and performs the liquid discharge step on the plate B (step S1). Next, the mounting part 44 is moved in the X-direction, the plate B is conveyed to the liquid supply area 22, and the liquid supply step is performed on the plate B (step S2). While steps S1 and S2 are performed on the plate B, the reaction 1 between a reaction liquid and a sample is performed on the plate A at a predetermined location on the first conveyance part 40 (step S3). In the reaction 1, the temperature control mechanism and the shaking mechanism are driven to perform the temperature control operation and the shaking operation, respectively, as necessary, on the plate A.

As described above, the period in which the liquid discharge and liquid supply steps (steps S1 and S2) are performed on the plate B overlaps the period in which the reaction 1 (step S3) is performed on the plate A.

Next, the first conveyance part 40 causes the mounting part 44 to move in the X-direction, conveys the plate C to the discharge area 21, and performs the liquid discharge step on the plate C (step S1). Then, the mounting part 44 is moved in the X-direction, the plate C is conveyed to the liquid supply area 22, and the liquid supply step is performed on the plate C (step S2). While steps S1 and S2 are performed on the plate C, the reaction 1 between the reaction liquid and the sample is performed on the plate B at a predetermined location on the first conveyance part 40 (step S3). In this processing, the reaction 1 on the plate A is continuously performed while the temperature control operation and the shaking operation are performed at a location adjacent to the plate B on the first conveyance part 40 (step S3).

As described above, the period in which the liquid discharge and liquid supply steps (steps S1 and S2) are performed on the plate C overlaps the period in which the reaction 1 (step S3) is performed on the plates A and B.

Next, the first conveyance part 40 causes the mounting part 44 to move in the X-direction, conveys the plate D to the discharge area 21, and performs the liquid discharge step on the plate D (step S1). Then, the mounting part 44 is moved in the X-direction, the plate D is conveyed to the liquid supply area 22, and the liquid supply step is performed on the plate D (step S2). While steps S1 and S2 are performed on the plate D, the reaction 1 between the reaction liquid and the sample is performed on the plate C at a predetermined location on the first conveyance part 40 (step S3). In this processing, the reaction 1 is continuously performed on the plates A and B while the temperature control operation and the shaking operation are performed at the location where the plate A is adjacent to the plate B and at the location where the plate B is adjacent to the plate C on the first conveyance part 40 (step S3).

As described above, the period in which the liquid discharge and liquid supply steps (steps S1 and S2) are performed on the plate D overlaps the period in which the reaction 1 (step S3) is performed on the plates A, B, and C.

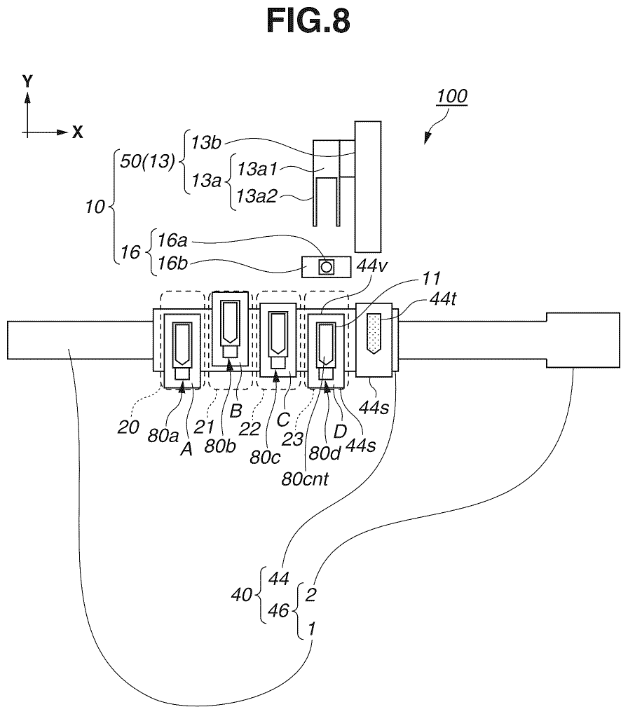

After the liquid is supplied to the plate D, the reaction 1 is performed on the plate D while the temperature control operation and the shaking operation are performed. The reaction 1 on the plates A to C is continuously performed while the temperature control operation and the shaking operation are performed. After the reaction 1 on the plate A ends, the liquid discharge and liquid supply steps (steps S4 and S5) and the reaction 2 (step S6) as the reaction step are sequentially performed on the plates A to D in the same manner as in the liquid discharge and liquid supply steps and the reaction 1 on the plates A to D described above. Examples of the liquid to be supplied in step S5 include a chemical liquid for decelerating or stopping the reaction of the sample in the reaction 1. In this case, the reaction 2 corresponds to a deceleration/stopping reaction for the reaction 1. Since the reaction 2 is performed as quickly as possible after the end of the reaction 1, the plate cleaning step is not performed between the liquid discharge step and the liquid supply step. FIG. 8 illustrates a state of the inspection device when the liquid supply step is performed on the plate C. FIG. 8 illustrates a state where the plates A, B, and D are shaken in the reactions 1 and 2.

In this processing, the period in which the liquid discharge and liquid supply steps (steps S4 and S5) are performed on the plate A overlaps the period in which the reaction 1 (step S3) is performed on the plates B, C, and D.

The period in which the liquid discharge and liquid supply steps (steps S4 and S5) are performed on the plate B overlaps the period in which the reaction 2 (step S6) is performed on the plate A, and also overlaps the period in which the reaction 1 (step S3) is performed on the plates C and D. The period in which the liquid discharge and liquid supply steps (steps S4 and S5) are performed on the plate C overlaps the period in which the reaction 2 (step S6) is performed on the plates A and B, and also overlaps the period in which the reaction 1 (step S3) is performed on the plate D. The period in which the liquid discharge and liquid supply steps (steps S4 and S5) are performed on the plate D overlaps the period in which the reaction 2 (step S6) is performed on the plates A, B, and C.

After the liquid is supplied to the plate D, the reaction 2 is performed on the plate D while the temperature control operation and the shaking operation are performed. The reaction 2 on the plates A to C is continuously performed while the temperature control operation and the shaking operation are performed. After the reaction 2 on the plate A ends, the liquid discharge and liquid supply steps (steps S7 and S8) and the reaction 3 (step S9) as a third reaction step are sequentially performed on the plates A to D in the same manner as in the liquid discharge and liquid supply steps and the reaction 2 on the plates A to D described above. Examples of the liquid that is supplied in step S8 include chemical liquids, including a labeling substance for visualizing the spots 12 that have reacted as a target, and a fluorescence substance for selectively fluorescent-labeling the spots 12. In this case, the reaction 3 is a fluorescent reaction for the spots 12. The plate cleaning step is performed several times between the liquid discharge step and the liquid supply step.

In this processing, the period in which the liquid discharge and liquid supply steps are performed on the plate A (steps S7 and S8) overlaps the period in which the reaction 2 (step S6) is performed on the plates B, C, and D.

The period in which the liquid discharge and liquid supply steps (steps S7 and S8) are performed on the plate B overlaps the period in which the reaction 3 (step S9) is performed on the plate A, and also overlaps the period in which the reaction 2 (step S6) is performed on the plates C and D. The period in which the liquid discharge and liquid supply steps (steps S7 and S8) are performed on the plate C overlaps the period in which the reaction 3 (step S9) is performed on the plates A and B, and also overlaps the period in which the reaction 2 (step S6) is performed on the plate D. The period in which the liquid discharge and liquid supply steps (steps S7 and S8) are performed on the plate D overlaps the period in which the reaction 3 (step S9) is performed on the plates A, B, and C.

After the liquid is supplied to the plate D, the reaction 3 is performed on the plate D while the temperature control operation and the shaking operation are performed. The reaction 3 on the plates A to C is continuously performed while the temperature control operation and the shaking operation are performed. After the reaction 3 on the plate A ends, the liquid discharge and liquid supply steps are sequentially performed on the plates A to D (steps S10 and S11) in the same manner as in the liquid discharge and liquid supply steps on the plates A to D described above. As a liquid to be supplied in step S11, an observation liquid is used for the subsequent measurement step. The plate cleaning step is performed several times between the liquid discharge step and the liquid supply step.

Examples of the observation liquid may include a so-called purge liquid for replacing optical background noise components. It may be desirable to use a liquid that is compatible with a liquid (stop solution for the reaction 2 in the present embodiment) used on the array plate in the preceding process (reaction 3 (step S9) in the present embodiment). The observation liquid has a refractive index closer to that of the array plate than air. The observation liquid may desirably have a refractive index of more than or equal to 1.3. From the viewpoint of being closer to the refractive index of the array plate, the observation liquid may more desirably have a refractive index of more than or equal to 1.33 to less than or equal to 1.60, and much more desirably, a refractive index of more than or equal to 1.40 to less than or equal to 1.46. The observation liquid is desirably a liquid containing glycerol with a volume concentration of more than or equal to 40 vol % to less than or equal to 90 vol % with respect to solvent water. Such an observation liquid is supplied to the reservoir 80cnt of the plate 80, whereby drying and discoloring of the spots 12 as a measurement location are prevented.

In this case, the period in which the liquid discharge and liquid supply steps (steps S10 and S11) are performed on the plate A overlaps the period in which reaction 3 (step S9) is performed on the plates B, C, and D. The period in which the liquid discharge and liquid supply steps (steps S10 and S11) are performed on the plate B overlaps the period in which the reaction 3 (step S9) is performed on the plates C and D, and also overlaps the period in which the measurement step (step S12) to be described below is performed on the plate A. The period in which the liquid discharge and liquid supply steps (steps S10 and S11) are performed on the plate C overlaps the period in which the reaction 3 (step S9) is performed on the plate D, and also overlaps the period in which the measurement step (S12) is performed on the plate B. The period in which the liquid discharge and liquid supply steps (steps S10 and S11) are performed on the plate D overlaps the period in which the measurement step (step S12) is performed on the plate C.

After the liquid supply step (step S11) on each of the plates A to D ends, the measurement step is sequentially performed on the plates A to D (step S12).

In the present embodiment, the first conveyance part 40 and the second conveyance part 50 are operated so that the plurality of plates 80 is held on the first conveyance part 40 to prevent the measurement step for each of the plurality of plates 80 from being started before the reaction 3 on the plurality of plates 80 is completed. In the present embodiment, a standby period is set between the end of the last liquid supply step and the start of the measurement step for the predetermined plate to prevent the conveyance operation from being performed by the first conveyance part 40 and the second conveyance part 50 on plates other than the plate during the period of the measurement step on the plate.

Specifically, after the liquid supply step (step S11) for the plate A ends, the plate A is in the standby period and the operations on the plate A are stopped. As for plate B, during the standby period of the plate A, the liquid supply step (step S11) for the plate B ends, the plate B is in the standby period, and the operations on the plate B are stopped. As for the plate C, during the standby period of the plates A and B, the liquid supply step (step S11) for the plate C ends, and the operations on the plate C are stopped. As for the plate D, during the standby period of the plates A, B, and C, the liquid supply step (step S11) for the plate D ends, the plate D is in the standby period, and the operations on the plate D are stopped.

After the standby period of the plate A ends, the measurement step (step S12) is performed on the plate A.

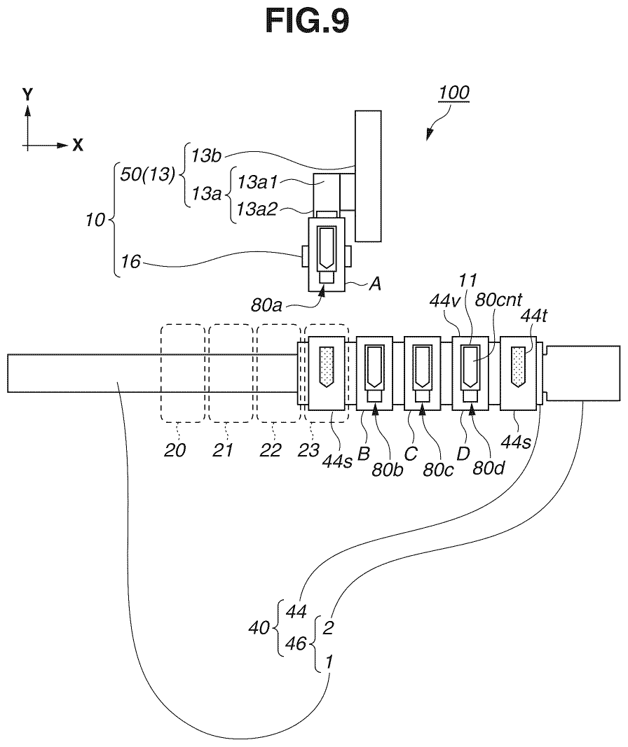

Specifically, the first conveyance part 40 causes the mounting part 44 to move in the X-direction and conveys the plate A to the relay area 23. Next, as illustrated in FIG. 9, the second conveyance part 50 causes the plate A located on the relay area 23 to move via the holding part 13a, and conveys the plate A to a predetermined position on the measurement part 10. The measurement scanning part 16b drives the optical measurement system 16a in the X-direction and the second conveyance part 50 drives the plate A in the Y-direction to perform two-dimensional scanning relative to the plate A, whereby a two-dimensional fluorescence image of the spots 12 on the reservoir 80cnt of the plate A is obtained.

During the measurement step for the plate A, the plates B, C, and D are in the standby period. After the measurement step for the plate A ends and all the steps for the plate A are completed, the standby period of the plate B ends and the measurement step (step S12) is performed on the plate B. During the measurement step for the plate B, the plates C and D are in the standby period. After the measurement step for the plate B ends and all the steps for the plate B are completed, the standby period of the plate C ends and the measurement step (step S12) is performed on the plate C. During the measurement step for the plate C, the plate D is in the standby period. After the measurement step for the plate C ends and all the steps for the plate C are completed, the standby period of the plate D ends and the measurement step (step S12) is performed on the plate D.

In the present embodiment, the measurement step is performed on each of the plate 80 in a state where the operations, such as the driving operation and the shaking operation by the first conveyance part 40 and the second conveyance part 50 on the other plates 80 that are not involved in the measurement step are stopped. With this configuration, adverse effects of oscillations, electric noise, and the like on the measurement step are reduced. If the operations, such as the driving operation and the shaking operation. by the first conveyance part 40 and the second conveyance part 50 have little effect or the effects of the operations fall within a predetermined allowable range, the standby period may be omitted as necessary.

In the present embodiment, the first conveyance part 40 causes the plurality of plates 80 to move in the X-direction, the second conveyance part 50 causes the predetermined plate 80 from among the plurality of plates 80 to move in the Y-direction, and the measurement scanning part 16b causes the optical measurement system 16a to move in the X-direction. These movements cause the plurality of plates 80 to be conveyed and some of the steps in the series of steps, including the liquid discharge and liquid supply steps, the reaction step, and the measurement step, are performed in an overlapping manner, as necessary, whereby the steps are effectively executed as successive processes. In the present embodiment, the period in which the liquid discharge and liquid supply steps are performed partially overlaps the period in which the reaction step is performed, which leads to an improvement in the efficiency of executing the steps.

### Modified Examples

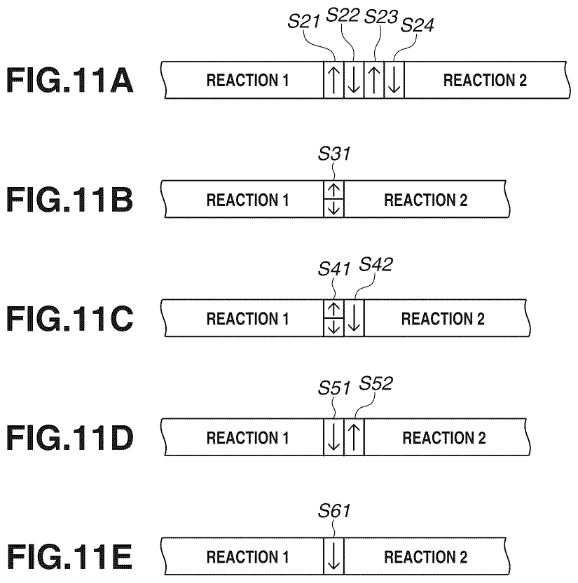

Modified examples of the present embodiment will be described below. While the present embodiment illustrates a case where steps S1 and S2, steps S4 and S5, steps S7 and S8, and steps S10 and S11 are sequentially performed on each of the plurality of plates 80 as the liquid discharge step and the liquid supply step, the present embodiment is not limited to this configuration. The present embodiment is not limited only to the case where one liquid supply step is performed after one liquid discharge step but may also be applied to a case in which the liquid discharge and liquid supply steps are performed a plurality of times, or the liquid supply step is performed simultaneously with the liquid discharge step or before the liquid discharge step. The present embodiment may also be applied to a case in which only the liquid supply step is performed without performing the liquid discharge step. As examples of such cases, modified examples will be described below with reference to FIGS. 11A to 11E. The following modified examples illustrate examples where the liquid discharge and liquid supply steps and the like are performed between the reaction 1 and the reaction 2 described in the present embodiment. However, the modified examples are not limited to these examples, and the liquid discharge and liquid supply steps and the like may be performed at any timing, for example, before the reaction 1, between the reaction 2 and the reaction 3, or after the reaction 3.

### Modified Example 1

FIG. 11A is a schematic diagram illustrating the liquid discharge and liquid supply steps according to Modified Example 1.

In Modified Example 1, a liquid discharge step S21, the liquid supply step S22, a liquid discharge step S23, and a liquid supply step S24 are sequentially performed on a selected array plate.

In the liquid discharge step S21, a chemical liquid including a sample stored in the array plate is discharged to reduce the amount of the sample. In this processing, a target bound to a biological material in the reaction 1 remains on the spots 12, and the target in which no reaction has occurred, or the target obtained after a chemical reaction or an enzymatic reaction has occurred in the biological material is reduced. In the liquid supply step S22, a chemical liquid for causing the deceleration/stopping reaction for the reaction 1 is supplied to the array plate. There may be a case in which the target on the array plate is insufficiently reduced in some cases.

Thus, in the liquid discharge step S23, the chemical liquid that is stored in the array plate and causes the deceleration/stopping reaction for the reaction 1 is discharged. In this processing, the target in which no reaction has occurred in the reaction 1, or the target obtained after a chemical reaction or an enzymatic reaction has occurred in the biological material is significantly reduced. In the liquid supply step S24, the chemical liquid for causing the deceleration/stopping reaction for the reaction 1 is supplied to the array plate again. In this processing, in the liquid discharge step S23 and the liquid supply step S24, the liquid discharge and liquid supply steps are performed on the same chemical liquid, and the chemical liquid is replaced. From the viewpoint of overall steps S21 to S24, the chemical liquid including the sample stored in the array plate is discharged and another chemical liquid (chemical liquid for causing the deceleration/stopping reaction for the reaction 1) is supplied and at least a part of the former chemical liquid is replaced with the latter chemical liquid.

### Modified Example 2

FIG. 11B is a schematic diagram illustrating a step in which liquid discharge and liquid supply are simultaneously performed according to Modified Example 2.

In Modified Example 2, a liquid discharge/liquid supply step S31 is performed on a selected array plate. In Modified Example 2, in the inspection device illustrated in FIG. 1 according to the present embodiment, the discharge area 21 and the liquid supply area 22 entirely overlap each other, and the liquid supply area 22 also serves as the discharge area 21. In the liquid discharge/liquid supply step S31, an operation of discharging the chemical liquid including the sample stored in the array plate and an operation of supplying the chemical liquid for causing the deceleration/stopping reaction for the reaction 1 to the array plate are performed at once. In this processing, the target in which no reaction has occurred in the reaction 1, or the target obtained after a chemical reaction or an enzymatic reaction has occurred in the biological material is reduced, and the chemical liquid for causing the deceleration/stopping reaction for the reaction 1 is stored in the array plate. In this processing, in the liquid discharge/liquid supply step S31, the chemical liquid including the sample stored in the array plate is discharged and a different chemical liquid (chemical liquid for causing the deceleration/stopping reaction for the reaction 1) is supplied, and at least a part of the former chemical liquid is replaced with the latter chemical liquid. Depending on two predetermined reaction steps, the liquid discharge/liquid supply step S31 may be performed on the same chemical liquid. In this case, the chemical liquid is replaced.

### Modified Example 3

FIG. 11C is a schematic diagram illustrating a liquid discharge/liquid supply step according to Modified Example 3.

In Modified Example 3, a liquid discharge/liquid supply simultaneous step S41 and a liquid supply S42 are sequentially performed on a selected array plate.

In the liquid discharge/liquid supply simultaneous step S41, an operation of discharging the chemical liquid including the sample stored in the array plate and an operation of supplying the chemical liquid for causing the deceleration/stopping reaction for the reaction 1 to the array plate are performed at once.

In this processing, the target in which no reaction has occurred in the reaction 1, or the target obtained after a chemical reaction or an enzymatic reaction has occurred in the biological material is reduced, and the chemical liquid for causing the deceleration/stopping reaction for the reaction 1 is stored in the array plate. In this processing, there can be a case in which, only with the liquid discharge/liquid supply simultaneous step S41, the ratio of the chemical liquid for causing the deceleration/stopping reaction for the reaction 1 may be insufficient.

Thus, in the liquid supply step S42, the chemical liquid for causing the deceleration/stopping reaction for the reaction 1 is added to the array plate. In this processing, in the liquid discharge/liquid supply simultaneous step S41 and the liquid supply step S42, the chemical liquid including the sample stored in the array plate is discharged and a different chemical liquid (chemical liquid for causing the deceleration/stopping reaction for the reaction 1) is supplied, and at least a part of the former chemical liquid is replaced with the latter chemical liquid. Depending on two predetermined reaction steps, the liquid discharge/liquid supply simultaneous step S41 and the liquid supply step S42 may be performed on the same chemical liquid. In this case, the chemical liquid is replaced.

### Modified Example 4

FIG. 11D is a schematic diagram illustrating a liquid discharge/liquid supply step according to Modified Example 4.

In Modified Example 4, a liquid supply step S51 and a liquid discharge step S52 are sequentially performed on a selected array plate.

In the liquid supply step S51, the chemical liquid for causing the deceleration/stopping reaction for the reaction 1 is supplied to the array plate. In the liquid discharge step S52, a mixture of the chemical liquid including the sample and the chemical liquid for causing the deceleration/stopping reaction for the reaction 1 is discharged. In this processing, the target in which no reaction has occurred, or the target obtained after a chemical reaction or an enzymatic reaction has occurred in the biological material is reduced, and the ratio of the chemical liquid for causing the deceleration/stopping reaction for the reaction 1 is sufficient.

In this processing, in the liquid supply step S51 and the liquid discharge step S52, the chemical liquid for causing the deceleration/stopping reaction for the reaction 1 is supplied to the array plate and a different chemical liquid (chemical liquid including the sample) is supplied, and at least a part of the former chemical liquid is replaced with the latter chemical liquid. Depending on the former and latter reaction steps, the liquid supply step S51 and the liquid discharge step S52 may be performed on the same chemical liquid. In this case, the chemical liquid is replaced.

### Modified Example 5

FIG. 11E is a schematic diagram illustrating a liquid supply step according to Modified Example 5.

In Modified Example 5, only a liquid supply step S61 is performed on a selected array plate.

In the liquid supply step S61, the chemical liquid for causing the deceleration/stopping reaction for the reaction 1 is supplied to the array plate. In this processing, only the liquid supply step S61 is performed, and the ratio of the chemical liquid for causing the deceleration/stopping reaction for the reaction 1 is sufficient.

### Other Embodiments

In the inspection device according to the present embodiment, a computer including a CPU, a storage medium, such as a random access memory (RAM), a read-only memory (ROM), or a hard disk drive (HDD), a display unit, and an operation unit is applied as the controller 5 serving as the control unit. As a matter of course, the controller 5 is not limited to this configuration, but instead may be, for example, an information terminal, such as a personal digital assistant (PDA), a tablet personal computer (PC), or a mobile phone. As the display unit of the controller 5, various display devices, such as a liquid crystal display device, can be applied. As the operation unit of the controller 5, various input devices, such as a keyboard and a touch panel, can be applied. The ROM or the storage medium stores computer programs for controlling a removal system of a battery structure. Such computer programs are programs for implementing functions including the operations of the first conveyance part 40, the second conveyance part 50, the temperature control mechanism 44t, the shaking mechanism 44v, the plate tilt mechanism, the liquid supply mechanism, the optical measurement system 16a, and the measurement scanning part 16b, and are programs corresponding to steps S1 to S12 illustrated in FIG. 10, steps S21 to S24 illustrated in FIG. 11A, step S31 illustrated in FIG. 11B, steps S41 and S42 illustrated in FIG. 11C, steps S51 and S52 illustrated in FIG. 11D, and step S61 illustrated in FIG. 11E. The CPU of the controller 5 reads out the computer programs from the ROM or the storage medium, and executes the computer programs using the RAM as a work area. With this configuration, the controller 5 controls each unit of the inspection device.

The embodiments and various modifications described above are merely examples of how the present disclosure is implemented, and should not be interpreted as limiting the technical scope of the disclosure. In other words, the present disclosure can be implemented in various forms without departing from its technical concept or main features.

The disclosure of the present embodiment includes the following configurations, methods, and the like.

### (Configuration 1)

An inspection device that performs a liquid supply step of supplying a predetermined chemical liquid to a reservoir of a plate and performs a reaction step and a measurement step on the plate in which the chemical liquid is stored, the inspection device comprising a measurement part configured to perform the measurement step; a liquid supply area corresponding to a position where the liquid supply step of supplying a predetermined liquid to the reservoir is performed in the liquid supply step; a relay area corresponding to a position where the plate for which the reaction step has been completed is located; a first conveyance part including a mounting part on which a plurality of plates is mounted at different positions, respectively, the first conveyance part being configured to move the mounting part to locate a plate selected from among the plurality of plates mounted on the mounting part in the liquid supply area and the relay area at different times; and a second conveyance part configured to convey the selected plate located on the relay area to the measurement part, wherein the liquid supply step, which is performed on the selected plate, includes at least a period in which the liquid supply step is performed in parallel with the reaction step, which is performed on at least one of the plates other than the selected plate from among the plurality of plates.

### (Configuration 2)

The inspection device according to Configuration 1, wherein the first conveyance part extends along the different positions at which the plurality of plates is respectively mounted.

### (Configuration 3)

The inspection device according to Configuration 1 or 2, wherein a direction in which the first conveyance part moves the mounting part intersects a direction in which the second conveyance part conveys the selected plate.

### (Configuration 4)

The inspection device according to any one of Configurations 1 to 3, further comprising a mounting area corresponding to a position where a mounting step of mounting the plate on the mounting part is performed.

### (Configuration 5)

The inspection device according to Configuration 4, wherein the mounting area, the liquid supply area, and the relay area are arranged along a path for the first conveyance part to move the mounting part.

### (Configuration 6)

The inspection device according to any one of Configurations 1 to 5, comprising a discharge area corresponding to a position where a liquid discharge step of discharging the predetermined liquid from the reservoir of the selected plate is performed.

### (Configuration 7)

The inspection device according to Configuration 6, wherein at least two areas of the discharge area, the mounting area, the liquid supply area, and the relay area include an overlapping part.

### (Configuration 8)

The inspection device according to Configuration 7, wherein the overlapping part is a common area included in both the liquid supply area and the relay area.

### (Configuration 9)

The inspection device according to Configuration 6, wherein the first conveyance part conveys the selected plate so that the liquid supply step, which is performed on the selected plate, is executed at a timing that is at least one of simultaneously with the liquid discharge step, after the liquid discharge step, and before the liquid discharge step.

### (Configuration 10)

The inspection device according to Configuration 9, wherein replacement of the predetermined liquid stored in the reservoir of the selected plate is executed in the mounting part by performing the liquid discharge step and the liquid supply step on the selected plate.

### (Configuration 11)

The inspection device according to Configuration 9, wherein replacement of at least a part of the predetermined liquid stored in the reservoir of the selected plate with a different predetermined liquid is executed in the mounting part by performing the liquid discharge step and the liquid supply step on the selected plate.

### (Configuration 12)

The inspection device according to any one of Configurations 1 to 11, wherein the first conveyance part and the second conveyance part operate to hold the plurality of plates on the first conveyance part to prevent the measurement step from being started for any of the plurality of plates before the reaction step for the plurality of plates is completed.

### (Configuration 13)

The inspection device according to any one of Configurations 1 to 12, wherein the measurement part includes a substrate scanning part configured to move the selected plate in a predetermined direction.

### (Configuration 14)

The inspection device according to Configuration 13, wherein the second conveyance part includes a holding part configured to hold the selected plate conveyed to the relay area.

### (Configuration 15)

The inspection device according to Configuration 14, wherein the substrate scanning part moves the selected plate in the predetermined direction via the holding part.

### (Configuration 16)

The inspection device according to Configuration 14 or 15, wherein a moving speed for conveying the selected plate from the relay area to the measurement part is higher than a moving speed of the holding part in the measurement step, which is performed by the substrate scanning part.

### (Configuration 17)

The inspection device according to any one of Configurations 1 to 16, wherein the liquid stored in the reservoir of the plate in the measurement step has a refractive index of more than or equal to 1.40 to less than or equal to 1.46.

### (Configuration 18)

The inspection device according to any one of Configurations 1 to 17, wherein the liquid stored in the reservoir of the plate in the measurement step contains glycerol with a volume concentration of more than or equal to 40 vol % to less than or equal to 90 vol % with respect to solvent water.

### (Configuration 19)

The inspection device according to any one of Configurations 1 to 18, wherein the mounting part includes a shaking mechanism configured to shake the plurality of plates independently of each other.

### (Configuration 20)

The inspection device according to any one of Configurations 1 to 19, wherein the mounting part includes a temperature control mechanism configured to control temperature of the plurality of plates independently of each other.

### (Method 1)

An inspection method for inspecting a plurality of plates, comprising: a liquid supply step of causing the plurality of plates located at different positions, respectively, to integrally move, conveying a plate selected from among the plurality of plates to a liquid supply area, and supplying a predetermined chemical liquid to a reservoir of the selected plate; a reaction step of reacting the chemical liquid in the selected plate for which the liquid supply step has been completed; and a measurement step of causing the plurality of plates to integrally move, conveying the selected plate for which the reaction step has been completed to a relay area, conveying the selected plate from the relay area to a measurement part, and performing a measurement on the selected plate, wherein the liquid supply step, which is performed on the selected plate, includes at least a period in which the liquid supply step is performed in parallel with the reaction step, which is performed on at least one of the plates other than the selected plate from among the plurality of plates.

### (Program 1)

A program for causing a computer to execute steps of an inspection method according to Method 1.

The present disclosure is not limited to the above-described embodiments, and various changes and modifications can be made without departing from the spirit and scope of the disclosure. Therefore, the following claims are attached to disclose the scope of the disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An inspection device that performs a liquid supply step of supplying a predetermined chemical liquid to a reservoir of a plate and performs a reaction step and a measurement step on the plate in which the chemical liquid is stored, the inspection device comprising:
a measurement part configured to perform the measurement step;
a liquid supply area corresponding to a position where the liquid supply step of supplying a predetermined liquid to the reservoir is performed in the liquid supply step;
a relay area corresponding to a position where the plate for which the reaction step has been completed is located;
a first conveyance part including a mounting part on which a plurality of plates is mounted at different positions, respectively, the first conveyance part being configured to move the mounting part to locate a plate selected from among the plurality of plates mounted on the mounting part in the liquid supply area and the relay area at different times, the plate being; and
a second conveyance part configured to convey the selected plate located on the relay area to the measurement part,
wherein the liquid supply step, which is performed on the selected plate, includes at least a period in which the liquid supply step is performed in parallel with the reaction step, which is performed on at least one of the plates other than the selected plate from among the plurality of plates.

2. The inspection device according to claim 1, wherein the first conveyance part extends along the different positions at which the plurality of plates is respectively mounted.

3. The inspection device according to claim 1, wherein a direction in which the first conveyance part moves the mounting part intersects a direction in which the second conveyance part conveys the selected plate.

4. The inspection device according to claim 1, further comprising a mounting area corresponding to a position where a mounting step of mounting the plate on the mounting part is performed.

5. The inspection device according to claim 4, wherein the mounting area, the liquid supply area, and the relay area are arranged along a path for the first conveyance part to move the mounting part.

6. The inspection device according to claim 4, further comprising a discharge area corresponding to a position where a liquid discharge step of discharging the predetermined liquid from the reservoir of the selected plate is performed.

7. The inspection device according to claim 6, wherein at least two areas of the discharge area, the mounting area, the liquid supply area, and the relay area include an overlapping part.

8. The inspection device according to claim 7, wherein the overlapping part is a common area included in both the liquid supply area and the relay area.

9. The inspection device according to claim 6, wherein the first conveyance part conveys the selected plate so that the liquid supply step, which is performed on the selected plate, is executed at a timing that is at least one of simultaneously with the liquid discharge step, after the liquid discharge step, and before the liquid discharge step.

10. The inspection device according to claim 9, wherein replacement of the predetermined liquid stored in the reservoir of the selected plate is executed in the mounting part by performing the liquid discharge step and the liquid supply step on the selected plate.

11. The inspection device according to claim 9, wherein replacement of at least a part of the predetermined liquid stored in the reservoir of the selected plate with a different predetermined liquid is executed in the mounting part by performing the liquid discharge step and the liquid supply step on the selected plate.

12. The inspection device according to claim 1, wherein the first conveyance part and the second conveyance part operate to hold the plurality of plates on the first conveyance part to prevent the measurement step from being started for any of the plurality of plates before the reaction step for the plurality of plates is completed.

13. The inspection device according to claim 1, wherein the measurement part includes a substrate scanning part configured to move the selected plate in a predetermined direction.

14. The inspection device according to claim 13, wherein the second conveyance part includes a holding part configured to hold the selected plate conveyed to the relay area.

15. The inspection device according to claim 14, wherein the substrate scanning part moves the selected plate in the predetermined direction via the holding part.

16. The inspection device according to claim 14, wherein a moving speed for conveying the selected plate from the relay area to the measurement part is higher than a moving speed of the holding part in the measurement step, which is performed by the substrate scanning part.

17. The inspection device according to claim 1, wherein the liquid stored in the reservoir of the plate in the measurement step has a refractive index of more than or equal to 1.40 to less than or equal to 1.46.

18. The inspection device according to claim 1, wherein the liquid stored in the reservoir of the plate in the measurement step contains glycerol with a volume concentration of more than or equal to 40 vol % to less than or equal to 90 vol % with respect to solvent water.

19. The inspection device according to claim 1, wherein the mounting part includes a shaking mechanism configured to shake the plurality of plates independently of each other.

20. The inspection device according to claim 1, wherein the mounting part includes a temperature control mechanism configured to control temperature of the plurality of plates independently of each other.

21. An inspection method for inspecting a plurality of plates, comprising:
a liquid supply step of causing the plurality of plates located at different positions, respectively, to integrally move, conveying a plate selected from among the plurality of plates to a liquid supply area, and supplying a predetermined chemical liquid to a reservoir of the selected plate;
a reaction step of reacting the predetermined chemical liquid in the selected plate for which the liquid supply step has been completed; and
a measurement step of causing the plurality of plates to integrally move, conveying the selected plate for which the reaction step has been completed to a relay area, conveying the selected plate from the relay area to a measurement part, and performing a measurement on the selected plate,
wherein the liquid supply step, which is performed on the selected plate, includes at least a period in which the liquid supply step is performed in parallel with the reaction step, which is performed on at least one of the plates other than the selected plate from among the plurality of plates.

22. A non-transitory computer-readable storage medium storing a program for causing a computer to execute steps of an inspection method according to claim 21.
